(19) United States
(12) Patent Application Publication
(10) Pub. No.: US 2020/0211590 A1
(43) Pub. Date: Jul. 2, 2020

(54) HEAT ASSISTED MAGNETIC RECORDING MEDIA WITH OPTIMIZED HEAT SINK LAYER

(71) Applicant: UNIVERSITÄT DUISBURG-ESSEN, Essen (DE)

(72) Inventors: Dieter WELLER, San Jose, CA (US); Ruslan SALIKHOV, Duisburg (DE); Ulf WIEDWALD, Essen (DE); Michael FARLE, Mülheim (DE)

(73) Assignees: UNIVERSITÄT DUISBURG-ESSEN, Essen (DE); UNIVERSITÄT DUISBURG-ESSEN, Essen (DE)

(21) Appl. No.: 16/330,560

(22) PCT Filed: Sep. 6, 2016
(86) PCT No.: PCT/EP2016/070964

§ 371 Date: Mar. 5, 2019

(51) Int. Cl. G11B 5/66; G11B 5/012; G11B 5/73

(52) U.S. Cl. CPC G11B 5/66; G11B 2005/0021; G11B 5/7379; G11B 5/012

(57) ABSTRACT

A heat assisted magnetic recording disk drive comprises a magnetic recording media with a heat sink layer including at least a material being defined by the general structure Mₙ₊₁AXₙ, wherein M is a transition metal, A is an A-group element, X is C or N or a mixture of C and N, and n is a positive integer, or a material defined by the general structure Mₙ₊₁AXₙ, wherein M is a transition metal, X is one or both of C and N, and n is a positive integer, or a mixture of the materials being defined by the general structure Mₙ₊₁AXₙ and the material defined by the general structure Mₙ₊₁Xₙ, wherein the crystal structure of the materials is hexagonal with repeated M-X-M (quasi 2D) atomic layers. The atomic layers are stacked along the \vec{c}-axis that is oriented substantially parallel to the surface normal of the heat sink layer.

### CROSS-REFERENCE TO RELATED APPLICATIONS

This application is a National Stage of International Application No. PCT/EP2016/070964, filed on Sep. 6, 2016. The entire disclosure of the above application is incorporated herein by reference.

### FIELD

The present disclosure relates to a heat assisted magnetic recording disk drive comprising a magnetic recording media with a heat sink layer.

### BACKGROUND

This section provides background information related to the present disclosure which is not necessarily prior art.

Heat assisted magnetic recording (HAMR) is one of the most promising technologies for future hard disk drive applications with increased storage density. In the writing process of HAMR, a magnetic medium is heated above its Curie temperature by a laser beam. Using a near field optical transducer (NFT), the laser beam is concentrated to nanosize to locally heat the recording medium. The cooling rate of the magnetic medium needs to be fast enough to avoid the thermal destabilization of the recorded information during the cool down time of the medium.

The medium thermal profile has a direct impact on the recording performance and the recording density. The thermal profile formed on the recording medium depends on the optical profile generated by the optical transducer and also on the microstructure and the layer structure of the recording medium. It is known that the thermal gradient dominates the transition sharpness in HAMR and therefore the thermal gradient at the recording point determines the quality of the written transitions. It is found that strong heat-sinking of the media increases the thermal gradient.

To support the ultrahigh areal density recording, the thermal issue needs to be well managed not only from the light delivery part, but also from the medium layer structure design. Therefore to facilitate thermal management heat sink layers are used in HAMR media. The heat sink layer in the magnetic medium can help to provide minimal thermal spot sizes on the magnetic recording layer and data stability by removing the heat from the magnetic recording layer rapidly. As heat sink layers play a key role in the thermal control of the magnetic medium, materials with high thermal conductivity are preferred. In the prior art, for example Ag, Cu, and their alloys are candidates to act as a heat sink layer.

U.S. Pat. No. 8,576,672 describes a magnetic stack for a heat assisted magnetic recording media wherein a layer of the magnetic stack is configured as heat sink layer. The heat sink layer in the magnetic medium is used to achieve a specified thermal spot on the magnetic recording layer. It comprises different kinds of materials like conductors, lossy metal materials, dielectric materials, semiconductors and magnetic alloys.

The disadvantages of most of the materials used as a heat sink layer described in the prior art are that they show an isotropic heat conduction, wherein the thermal conductivity does not depend on the direction.

### SUMMARY

This section provides a general summary of the disclosure, and is not a comprehensive disclosure of its full scope or all of its features.

The objective of the present disclosure is to provide a heat assisted magnetic recording disk drive comprising a magnetic recording media with a heat sink layer, wherein the storage density of the magnetic recording media is increased.

According to the disclosure, this object is achieved in that the heat sink layer comprises at least a material being defined by the general structure Mₙ₊₁AXₙ, wherein M is a transition metal, A is an A-group element, X is C or N or a mixture of C and N, and n is a positive integer, or a material defined by the general structure Mₙ₊₁Xₙ, wherein M is a transition metal, X is one or both of C and N, and n is a positive integer, or a mixture of the materials being defined by the general structure Mₙ₊₁AXₙ and the material defined by the general structure Mₙ₊₁Xₙ, wherein the crystal structure of the materials is hexagonal with repeated M-X-M (quasi 2D) atomic layers, the atomic layers are stacked along the \vec{c}-axis and the \vec{c}-axis is oriented substantially parallel to the surface normal of the heat sink layer.

The materials being defined by the general structure Mₙ₊₁AX, are called “MAX phases” due to their chemical formula. All known MAX phases have a layered hexagonal structure with P6₃/mmc symmetry, where the M layers are nearly closed packed, and the X atoms fill the octahedral sites. The Mₙ₋₁Xₙ layers are interleaved with the A element. In other words, the MAX phase structure can be described as 2D layers of early transition metal carbides and/or nitrides wherein an A element is metallically bonded to the M element.

The materials being defined by the general structure Mₙ₊₁Xₙ are called “MXenes”. MXenes adopt the structures inherited from the parent MAX phases. They are produced by selectively etching out the A element from a MAX phase.

It was found that materials with an anisotropic heat conduction wherein the thermal conductivity varies with direction will sharpen the thermal gradient and therefore improve and sharpen the bit size of the magnetic media. According to the disclosure, the storage density of the magnetic recording media is increased by an optimized thermal gradient at the recording point.

Studies have shown that MAX phases and MXenes exhibit unusual and exceptional mechanical, electrical, thermal and chemical properties. They are electrically and thermally conductive due to their metallic-like nature of bonding. The key properties of the MAX phases and MXenes for their use as heat sink layers are their anisotropic thermal and electrical conductivities. The thermal and electrical conductivities in the direction parallel to the \vec{c}-axis are 100 to 1000 times smaller with respect to the conductivities within the M-X-M plane perpendicular to the \vec{c}-axis. Due to the orientation of the MAX phases or the MXenes in the heat sink layer and their 2D heat conductivity the heat wave contact area is enlarged. This promotes more efficient heat sinks wherein the heat is expanded laterally, only in the heat sink and not in the magnetic media. The thermal gradient is enlarged removing the heat more efficiently from the thermal spot in the media and preventing the spread of the same. MAX phase or MXene materials with the largest electronic contribution to the thermal conductivity and with the largest anisotropy of electrical conductivity are preferred for replacing isotropic metallic heat sink layers in HAMR media.

Advantageously, the transition metal is selected from the group consisting of Sc, Ti, V, Cr, Mn, Zr, Nb, Mo, Tc, Lu, Hf, Ta, W or a combination of these elements.

Further, advantageously the A-group element is selected from the group consisting of Al, Si, P, S, Ga, Ge As, Cd, In, Sn, Sb, Tl, Pb, Bi or a combination of these elements.

According to a preferred embodiment of the disclosure the atomic layers are repeated along the \vec{c}-axis to define an optimal thickness based on the system requirements. The heat sink layer according to the present disclosure maybe a single layer or a multi-layer structure.

The most promising compounds for replacing isotropic metallic heat-sink layers in HAMR media are Ti₂AlC and Ti₃SiC₂ due to their high electrical and thermal conductivities. The main reason of the good thermal conductivities in these compounds is their good electrical conductivity. According to Wiedmann-Franz Law the electronic contribution to the total thermal conductivity, kₑ, can be estimated as kₑ=L₀T/ρ, where L₀ is the classical Lorenz number (L₀=2.45·10⁻⁸ WΩ/K²) and ρ is the electrical resistivity at temperature T. The electronic contribution to the total thermal conductivity at T=300 K and 1300 K for Ti₃SiC₂ is about 30 W/(m·K), which is 97% of the total thermal conductivity. Thus, in these systems, where thermal conductivity is mostly defined by kₑ the largest anisotropy in thermal conductivities is expected due to anisotropic electrical properties. The anisotropic heat conduction is required for sharpen the thermal gradient what is the objective of the present disclosure.

The heat sink layer determines how fast the magnetic volume cools down wherein increasing the thermal conductivity or the thickness will result in lower temperatures in the magnetic media. Due to the excellent anisotropic thermal properties of the MAX phases or the MXenes the thickness of the heat sink layer can be thinner compared to the heat sink layers known from the prior art. Advantageously, the MAX phase or MXene layer thickness can be thinned at least down to about 10 nm.

The absolute thermal conductivity of the heat sink layer is another factor that affects the thermal gradient and therefore the removal from heat of the thermal spot. Due to the fact that MAX phases or MXenes possess metal-like properties their electrical and thermal conductivity are sufficiently high ensuring a high thermal gradient in the magnetic media.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In the drawings:

FIG. 1 is a cross sectional diagram of a heat assisted magnetic recording media.

FIG. 2 is a cross sectional diagram of a heat sink layer comprising a material being defined by the general structure Mₙ₋₁AXₙ.

FIG. 3 is a cross sectional diagram of a heat sink layer comprising a material being defined by the general structure Mₙ₋₁Xₙ.

Corresponding reference numerals indicate corresponding parts throughout the several views of the drawings.

### DETAILED DESCRIPTION

Example embodiments will now be described more fully with reference to the accompanying drawings.

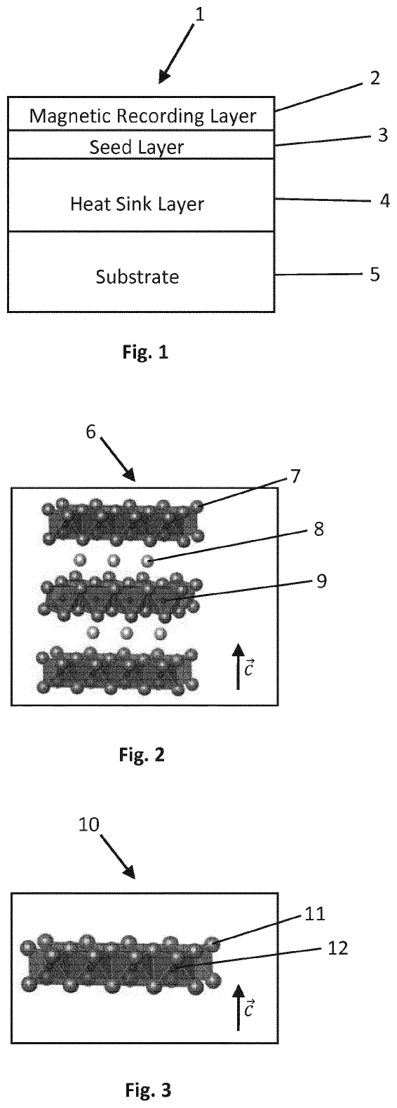

FIG. 1 is a cross sectional diagram of a heat assisted magnetic recording media 1 including a heat sink layer 4. The magnetic recording media 1 comprises a substrate 5, the heat sink layer 4 disposed over the substrate 5, a seed layer 3 disposed between the heat sink layer 4 and a magnetic recording layer 2. The substrate 5 may be made of any suitable material, such as ceramic glass, amorphous glass, or NiP coated Al—Mg alloy. The seed layer 3 utilizes e.g. MgO underlayers to induce the proper growth mode of the magnetic recording layer 2. The magnetic recording layer 2 may include crystalline grains of magnetic material, such as L1₀-chemically-ordered iron-platinum alloy film segregated by a non-magnetic material, such as an oxide, a carbide or a nitride. The heat sink layer 4 may be a single layer or a multi-layer structure, wherein the heat sink layer 4 comprises at least a material being defined by the general structure Mₙ₊₁AXₙ or by the general structure Mₙ₊₁Xₙ.

FIG. 2 shows a cross section of a heat sink layer 6 and illustrates the layer structures of the MAX phases being defined by the general structure Mₙ₊₁AXₙ in which the transitional metal carbide and/or nitride layers are interleaved with layers of pure A-group element and each X atom 9 is positioned within an octahedral array of M atoms 7. The MAX phases are oriented substantially with their c-axis parallel to the surface normal of the heat sink layer.

FIG. 3 shows a cross section of a heat sink layer 10 and illustrates the layer structures of the MXenes being defined by the general structure Mₙ₋₁Xₙ. Because MXenes adopt the structures inherited from the parent MAX phases the M atoms 11 are arranged within the Mₙ₊₁Xₙ framework, wherein each X atom 12 is positioned within an octahedral array of M atoms 11. The MXenes are oriented substantially with their c-axis parallel to the surface normal of the heat sink layer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A heat assisted magnetic recording disk drive comprising a magnetic recording media with a heat sink layer, wherein
the heat sink layer comprises
at least a material being defined by the general structure Mₙ₊₁AXₙ, wherein M is a transition metal, A is an A-group element, X is C or N or a mixture of C and N, and n is a positive integer, or
a material defined by the general structure Mₙ₊₁Xₙ, wherein M is a transition metal, X is one or both of C and N, and n is a positive integer, or
a mixture of the materials being defined by the general structure Mₙ₊₁AXₙ and
the material defined by the general structure Mₙ₊₁Xₙ, wherein
the crystal structure of the materials is hexagonal with repeated M-X-M (quasi 2D) atomic layers,
the atomic layers are stacked along the \vec{c}-axis and
the \vec{c}-axis is oriented substantially parallel to the surface normal of the heat sink layer.

2. The heat assisted magnetic recording disk drive of claim 1, wherein the transition metal is selected from the group consisting of Sc, Ti, V, Cr, Mn, Zr, Nb, Mo, Tc, Lu, Hf, Ta, W or a combination of these elements.

3. The heat assisted magnetic recording disk drive of claim 1, wherein the A-group element is selected from the group consisting of Al, Si, P, S, Ga, Ge As, Cd, In, Sn, Sb, Tl, Pb, Bi or a combination of these elements.

4. The heat assisted magnetic recording disk drive of claim 1, wherein the atomic layers are repeated along the \vec{c}-axis.

5. The heat assisted magnetic recording disk drive of claim 1, wherein Mₙ₋₁AXₙ is Ti₂AlC, Ti₃SiC₂, etc.

6. The heat assisted magnetic recording disk drive of claim 1, wherein the thickness of the heat sink layer is between 10 nm and 50 nm, preferably between 10 nm and 20 nm.

7. The heat assisted magnetic recording disk drive of claim 1, wherein the thermal conductivity of heat sink layer is between 30 W/m/K and 200 W/m/K, preferably between 30 W/m/K and 50 W/m/K.
